(19) United States
(12) Patent Application Publication
(10) Pub. No.: US 2008/0057206 A1
(43) Pub. Date: Mar. 6, 2008

(54) Hydraulic cement compositions and method of forming floor underlayment

(76) Inventors: John D. Igo, Norman, OK (US); Jacob H. De Souza, Enid, OK (US)

Correspondence Address: Clifford C. Dougherty, III;McAfee & Taft, Two Leadership Square, Tenth Floor, 211 North Robinson, Oklahoma City, OK, 73102, US

(21) Appl. No.: 11/514,756

(22) Filed: Sep. 1, 2006

(51) Int. Cl. C04B 7/00; B05D 1/36

(52) U.S. Cl. 427/403; 106/735

(57) ABSTRACT

The present invention provides a floor underlayment cement composition comprising at least about 95% by weight, based on the weight of the composition, of a hydraulic cementitious mixture and at least about 0.03% by weight, based on the weight of the composition, of a superplasticizer. The hydraulic cementitious mixture includes in the range of from about 35% to about 65% by weight, based on the weight of the mixture, of ground, granulated blast furnace slag, and in the range of from about 35% to about 65% by weight, based on the weight of the mixture, of a gypsum component selected from the group consisting of alpha-calcium sulfate hemihydrate, beta-calcium sulfate hemihydrate and mixtures thereof. It is not necessary to include Portland cement or aluminous cement in the hydraulic cementitious mixture. A floor underlayment slurry and a method of forming a high strength floor underlayment on a floor substrate are also provided.

### FIELD OF THE INVENTION

This invention broadly relates to hydraulic cement compositions and methods of using the same. More specifically, but not by way of limitation, the invention relates to floor underlayment cement compositions and methods of forming high strength underlayments on floors.

### BACKGROUND OF THE INVENTION

Pourable floor underlayments, also known as self leveling underlayments or “SLU's,” are commonly used in the construction and renovation of buildings, houses and other structures to form a level surface on wood and cement subfloors. The pourable floor underlayments operate to cover up imperfections in the subfloors thereby allowing finished floor coverings such as tile and carpet to be professionally applied thereto. Added benefits of pourable floor underlayments include their resistance to fire and noise attenuating characteristics (for example, in floor ceiling assemblies).

A unique advantage of pourable floor underlayments is that they are self-leveling. Due to their self-leveling ability, pourable floor underlayments require very little labor to finish the surface of the poured mixture to a “smoothness” suitable to receive finished floor goods.

Many characteristics of a pourable floor underlayment are important. The composition needs to be easy and relatively inexpensive to manufacture, package, ship and install. The raw components of the composition must have consistent qualities and properties. The cement mixture must be self-leveling and have a low water demand and reasonable set time. The resulting floor underlayment must have a sufficient compressive strength and be sufficiently durable for its intended use. Furthermore, once the underlayment is poured and allowed to harden, it must not expand or shrink excessively. Excessive expansion or shrinkage can result in cracks or cause the surface to delaminate from the corresponding substrate.

Many types of pourable floor underlayment compositions have been developed including Portland cement based compositions, gypsum based compositions, and tailor-engineered blends of various hydraulic cement compositions. Each type of composition has advantages with respect to cost, water resistance, compressive strength, durability and/or other properties. Most pourable floor underlayment compositions consist of a hydraulic cement mixture (hydraulic cement and other components) that is in the form of a dry powder and either pre-mixed with sand and packaged, or mixed with sand on the construction site just prior to mixing with water. The sand and dry powder is mixed with enough water to form a pumpable or pourable slurry that easily finishes to a flat, smooth surface without the need for troweling.

Pourable floor underlayment compositions are often packaged with the sand blended with the dry underlayment powder for several reasons. Convenience is often a big factor, especially when the equipment needed to blend sand at the construction site is not available or otherwise not readily accessible. Special sands with controlled particle size distribution and particle shapes are often used to optimize the flowability and water demand of a composition. Sands that are overly coarse or contain too many fine particles, which is often the case with typical concrete sands, will not flow well and may require excess water to function properly. The net result will be a lower compressive strength underlayment, and cracking may be a problem. Another benefit of controlling the amount and type of sand is it allows the manufacturer to control the ratio of water to cement in the poured underlayment. Some pourable floor underlayments are designed to dry very rapidly; others require very precise amounts of water in order to prevent cracking, soft surfaces, or low compressive strength.

Pourable floor underlayments that can be mixed with sand and water at the construction site in a variable manner are beneficial due to the reduced cost associated therewith. Locally sourced bulk sand is much less expensive than dried and packaged sand.

A traditional hydraulic cement that is commonly used in floor underlayment compositions is Portland cement. Portland cement is principally composed of silicates, aluminates and aluminosilicates of calcium that are reactive with water. Portland cement is relatively inexpensive, widely available and capable of hardening into a mass that is substantially unaffected by exposure to water and has a very high compressive strength.

Another traditional hydraulic cement that has been used in floor underlayment compositions is calcium aluminate cement (“CAC”). Calcium aluminate cement is normally blended with Portland cement and gypsum to create a pourable floor underlayment that dries rapidly and has a high compressive strength. Pourable floor underlayments formulated with calcium aluminate cement reach high compressive strengths more rapidly than those formulated with Portland cement alone due to the formation of etteringite, a byproduct of the hydration of calcium aluminate and gypsum. Etteringite formation consumes large amounts of the mix water, and enables compositions to be formulated that consume essentially all of the mix water, resulting in very rapid drying times (3 to 4 hours). On the down side, calcium aluminate cement is limited in supply and is expensive to manufacture. Pourable floor underlayments made with Portland cement or calcium aluminate cement and Portland cement blends are sensitive to the water cement ratio, and are normally pre-blended with sand so that a precise amount of water can be used for predictable performance.

Another type of cementitious material commonly used in floor underlayment compositions is gypsum plaster. Gypsum plaster, also referred to as gypsum cement, plaster of Paris and by other names, is composed of calcium sulfate hemihydrate. Gypsum plasters are readily available in several commercial grades, including beta gypsum and alpha gypsum. Pourable underlayments made from gypsum plaster can be pre-mixed with sand for convenience and performance, but normally sand is added at the construction site. Unlike the Portland cement and calcium aluminate cement based underlayments described above, gypsum plaster underlayments are not as sensitive to the specific water:plaster ratio used therein. The use of too much water in connection with gypsum underlayments can lead to undesirable effects such as soft or dusty underlayments, however, gypsum underlayments are generally much less prone to cracking and delamination during or after hydration, even if the ratio of water to plaster is not optimal. Generally, less water results in higher compressive strength underlayments, and more water will lower the compressive strength. As long as the sand is not overly coarse or fine, it can be mixed at varying ratios with the powder and water. Unlike Portland cement and calcium aluminate cement based underlayments, gypsum plaster underlayments are permeable to water, and the strength and durability of the underlayments can be compromised by excessive or repeated exposure to water.

Pozzolanic blended cements are also used in connection with pourable floor underlayments. Numerous types of pozzolanic binders have been identified and are used to enhance the behavior of Portland cement or calcium aluminate cement/Portland cement based underlayments. A pozzolanic material contains enough amorphous silica or silica and alumina to react readily in the presence of hydroxide ions that are generated during the hydration of Portland cement. Generally, pozzolans have little cementitious value alone, but when they are mixed with Portland cement and/or a hydroxide source, they can hydrate and improve the properties of the cement paste. For this reason, pozzolans generally require added Portland cement (or a hydroxide ion source) in order to harden.

Some materials such as Class C fly ash and granulated blast furnaces slag are pozzolanic in nature, but can produce their own source of hydroxide. These materials can harden without the addition of Portland cement, but typically are used as additives to Portland cement based compositions in order to enhance their performance.

Fly ash is a pozzolanic material that has been used in floor underlayment compositions. Fly ash is a waste material typically recovered from coal-burning furnaces. Certain classes of fly ash contain a substantial quantity of lime (CaO). Depending on the amount of lime it contains, fly ash will react with water and ultimately harden into a mass having a high compressive strength. However, fly ash is slow to hydrate and set. Further, the qualities and properties of fly ash are not always consistent which makes the characteristics of cement compositions containing fly ash difficult to predict.

Granulated blast furnace slag (“GBFS”) is yet another pozzolanic material that has been used in floor underlayment compositions. Granulated blast furnace slag is a nonmetallic agglomerate that develops in a molten condition with iron in a metal smelting process. It consists essentially of silicates and alumina silicates of calcium and other bases. Granulated blast furnace slag forms when the molten blast furnace slag is rapidly chilled, as by immersion in water. Blast furnace slag is a hydraulic cement material in that it is capable of hydrating underwater, but like fly ash it is more generally referred to as a pozzolanic material.

Granulated blast furnace slag is capable of hardening into a mass having a high compressive strength. However, like fly ash, granulated blast furnace slag takes a relatively long time to hydrate and set and therefore has not been considered suitable for use as a predominant cementitious material in floor underlayment compositions. It has been generally believed that granulated blast furnace slag must be blended with Portland cement or hydrated lime in order to produce a cement composition that has a reasonable hydration and set time. Also, it has been thought that too much granulated blast furnace slag will cause the hardening floor underlayment mixture and resulting underlayment to shrink and crack.

A composition utilizing Class C fly ash and gypsum plaster is disclosed in U.S. Pat. No. 5,439,518 to Francis et al. In this composition, Portland cement is not utilized to activate and harden the Class C fly ash. Instead, the Class C fly ash relies on the early hydration of the gypsum plaster to provide reasonable early strength. Over time, the Class C fly ash continues to hydrate and results in a harder, more water resistant underlayment than traditional gypsum based underlayments. Like gypsum underlayments, this composition can be mixed with sand and water at the construction site.

An example of a floor underlayment composition that includes blast furnace slag is disclosed by U.S. Pat. No. 5,873,936 to Ogden. This composition comprises about 10% to about 25% by weight of a fine aggregate, about 20% to about 35% by weight blast furnace slag cement, about 20% to about 35% by weight gypsum, about 4% to about 30% by weight Portland cement and about 0.3% to about 3% by weight of a cement plasticizer. It is stated that the amount of the blast furnace slag is critical. For example, it is stated that if an amount in excess of 35% by weight is used, the blast furnace slag cement may result in undesirable shrinkage and cracking in a finished floor coating made from the composition. This composition requires the use of Portland cement.

While the floor underlayment compositions developed and used heretofore have been effective, there is a continuing need for improved floor underlayment cement compositions and methods of using the same. Most resilient floor covering manufacturers recommend a minimum compressive strength of 3,000-3,500 psi. Furthermore, many in the construction industry require that the pourable underlayment exhibit increased strength over a 28 day moist curing cycle. While Portland cement formulations, calcium aluminate cement based formulations and blended pozzolanic materials will exhibit these characteristics, they generally require that they be packaged with sand at the manufacturer's facility in order to control the ratio of water to cement. Pourable gypsum underlayments can be mixed on site with sand and water, but do not gain an appreciable amount of strength over a 28 day wet curing cycle, and the compressive strength can be significantly compromised by saturation with water. The compositions disclosed in U.S. Pat. No. 5,873,936 to Ogden et al. and U.S. Pat. No. 5,439,518 to Francis et al. provide for continued strength gain over 28 days and can be mixed with sand on site. Other compositions that exhibit these properties are desirable because of the reduction in installed costs these types of materials represent.

A final consideration for pourable underlayments is the requirement for shot blasting or surface grinding of concrete subfloors prior to the installation of Portland cement and calcium aluminate cement based systems. Obtaining a strong bond between the pourable underlayment and the concrete is essential, especially in cases where the installed underlayments either expand or shrink. Shot blasting and surface grinding prepares the surface by removing any weakly bonded cement paste from the surface and creates a rough surface profile that allows the poured underlayment to bond more effectively. In some instances a two part epoxy bonding system (priming system) can be used without shot blasting or surface grinding, but the concrete surface must be structurally sound with no weakly bonded grouts, impurities or cement paste present on the surface of the concrete. Additional types of surface preparation agents such as redispersible latex or non-rewettable water based acrylic surface preparation agents (primers) are used to seal the concrete surface and act as a bonding agent to the poured underlayments.

The compositions described in U.S. Pat. No. 5,873,936 to Ogden and U.S. Pat. No. 5,439,518 to Francis do not require shot blasting prior to installation provided there are no weakly bonded contaminants on the surface or there is no weakly bonded cement paste on the surface of the concrete. All pourable underlayments either benefit from or require the use of a surface primer, such as redispersible latex or water based acrylic. Portland cement based and calcium aluminate cement based systems require either shot blasting, surface grinding or an epoxy primer. The requirement of shot blasting or epoxy priming substantially increases the cost of the poured underlayment.

### SUMMARY OF THE INVENTION

In accordance with the present invention, a hydraulic cement composition that is particularly useful as a floor underlayment cement composition is provided. The hydraulic cement composition comprises at least about 95% by weight, based on the weight of the composition, of a hydraulic cementitious mixture. The hydraulic cementitious mixture includes in the range of from about 35% to about 65% by weight, based on the weight of the mixture, of ground, granulated blast furnace slag, and in the range of from about 35% to about 65% by weight, based on the weight of the mixture, of gypsum plaster. The hydraulic cementitious mixture preferably consists of said ground, granulated blast furnace slag and said gypsum plaster. The hydraulic cement composition preferably also comprises at least about 0.03% by weight, based on the weight of the composition, of a cement plasticizer.

When mixed with an additional aggregate such as sand and sufficient water, the inventive hydraulic cement composition is capable of setting into a hardened mass that has a compressive strength of at least 1000 psi within 24 hours after the composition is poured. It can ultimately harden into a mass having a compressive strength as high as 8,000 psi.

Additives that can be included in the inventive hydraulic cement composition include one or more set modifying agents (i.e., set retarding and/or set accelerating agents), gypsum hydration expansion controlling agents, flow enhancing polymers, anti-foaming agents and rheology modifying agents. The specific additives included in the inventive composition will depend on the application involved and the conditions associated therewith, the set time needed or desired and other factors.

The invention also provides a floor underlayment cement mixture comprising a floor underlayment cement composition, additional aggregate, and water present in an amount sufficient to provide a pumpable, free-flowing, self-leveling formulation. The floor underlayment cement composition includes at least about 95% by weight, based on the weight of the composition, of a hydraulic cementitious mixture, and at least about 0.03% by weight, based on the weight of the composition, of a cement plasticizer. The hydraulic cementitious mixture includes in the range of from about 35% to about 65% by weight, based on the weight of the mixture, of ground, granulated blast furnace slag, and in the range of from about 35% to about 65% by weight, based on the weight of the mixture, of gypsum plaster. The hydraulic cementitious mixture preferably consists of the ground, granulated blast furnace slag and the gypsum plaster. The hydraulic cement composition and the additional aggregate are present in the mixture in a weight ratio in the range of from about 1:1 to about 1:2.25. The inventive cement mixture is capable of setting into a hard mass having a compressive strength of at least about 1000 psi within about 24 hours. It can be applied in thicknesses exceeding about 1.5 inches without the occurrence of substantial shrinkage during the set process, depending on the amount of sand.

The invention also provides a method of forming high strength floor underlayment on a base surface. The method comprises: (a) preparing or providing the inventive floor underlayment cement composition, as described above; (b) combining the floor underlayment cement composition with an additional aggregate and water to form a cement mixture, the floor underlayment cement composition and the additional aggregate being present in the mixture in a weight ratio in the range of from about 1:1 to about 1:2.25, and the water being present in the mixture in an amount sufficient to provide a pumpable, free-flowing self-leveling mixture; (c) placing the mixture on the base surface; and (d) allowing the mixture to set into an underlayment having a compressive strength in the range of from about 1,000 psi to about 8,000 psi. Preferably, the mixture is allowed to set into an underlayment having a compressive strength of from about 2000 psi to about 8000 psi.

The inventive composition does not require the use of Portland or calcium aluminate cements (CAC's), and can be mixed on the construction site with additional sand and water to form a pumpable slurry. Despite the absence of Portland and/or calcium aluminate cement, however, floor underlayments formed with the inventive composition have compressive strengths that are comparable to the compressive strengths of floor underlayments formed using such materials. The use of a hydraulic cementitious mixture of ground, granulated blast furnace slag and gypsum plaster yields excellent, synergistic results. The hydration of gypsum plaster provides sufficient early strength. Mixtures can be formed that set into a compressive strength of at least about 1000 psi, which is sufficient for light construction traffic, within 24 hours after the mixtures are poured. The ultimate strength is achieved due to the combined effect of delayed blast furnace slag hydration and early gypsum plaster hydration. The mixtures can be formulated such that compressive strengths of over 8,000 psi subsequently develop (Portland cement and/or an additional hydroxide ion source is not required to achieve such a compressive strength). Even though a high amount of blast furnace slag is present in the composition, shrinkage, cracking and other problems are minimal. Furthermore, there is not a requirement for shot blasting or surface grinding prior to pouring over concrete surfaces, provided that the surface is clean and free from loosely bonded material. The surface should be sealed and primed for bonding with a water based acrylic sealer to promote a strong bond between the composition and the concrete, and to prevent any adverse reactions between the inventive composition and materials on or in the concrete surface (surface priming is necessary for all types of pourable underlayments).

The objects, features and advantages of the present invention will be readily apparent to those skilled in the art upon a reading of the detailed description of the invention set forth below.

### DETAILED DESCRIPTION OF THE INVENTION

The present invention provides a hydraulic cement composition and methods of using the same. Although it can be used in other applications as well, the hydraulic cement composition is particularly useful as a floor underlayment cement composition. A method of forming a high strength floor underlayment on a base surface is also provided.

The inventive hydraulic cement composition preferably comprises at least about 95% by weight, based on the weight of the composition, of a hydraulic cementitious mixture, and at least about 0.03% by weight, based on the weight of the composition, of a cement plasticizer. Unless stated otherwise, the percent by weight of a component of the inventive composition (or a component of the hydraulic cementitious mixture) is the percent by weight of the component based on the weight of the dry composition (or hydraulic cementitious mixture) before the addition of water and any additional aggregate (for example, sand) to the composition.

The hydraulic cementitious mixture comprises two separate hydraulic cementitious materials, namely in the range of from about 35% to about 65% by weight, based on the weight of the mixture, of ground, granulated blast furnace slag, and in the range of from about 35% to about 65% by weight, based on the weight of the mixture, of gypsum plaster. As used herein, a hydraulic cementitious material means a material which sets and develops strength by chemical reaction with water to form one or more hydrates and is capable of doing so under water. In the inventive composition, the ground, granulated blast furnace slag and the gypsum plaster operate individually and collectively to contribute to the strength of the floor underlayment.

The precise amounts of the blast furnace slag and gypsum plaster included in the hydraulic cementitious mixture of the inventive composition will vary within the above ranges depending on the desired compressive strength of the resulting floor underlayment or other product and other factors known to those skilled in the art. Preferably, the hydraulic cementitious mixture includes in the range of from about 50% to about 60% by weight of the ground, granulated blast furnace slag, and in the range of from about 40% to about 50% by weight of the gypsum plaster, the weight percents being based on the weight of the hydraulic cementitious mixture. Most preferably, the hydraulic cementitious mixture includes in the range of from about 50% to about 55% by weight of the ground, granulated blast furnace slag, and in the range of from about 45% to about 50% by weight of the gypsum plaster, the weight percents being based on the weight of the hydraulic cementitious mixture. The hydraulic cementitious mixture of the inventive composition preferably consists of the ground, granulated blast furnace slag and the gypsum plaster in amounts within the above ranges.

Similarly, the precise amounts of the hydraulic cementitious mixture and the cement plasticizer included in the inventive composition will vary depending on the desired final compressive strength, the intended use (as a pourable underlayment, patching compound, etc), and the desired early strength. Compositions containing more gypsum plaster will yield higher early strengths. Preferably, the inventive composition comprises in the range of from about 95% to about 99.97% by weight of the hydraulic cementitious mixture, and in the range of from about 0.03% to about 2% by weight of the cement plasticizer, the weight percents being based on the weight of the composition. More preferably, the composition comprises in the range of from about 99% to about 99.97% by weight of the hydraulic cementitious mixture and in the range of from about 0.03% to about 1.0% by weight of the cement plasticizer, the weight percents being based on the weight of the composition.

The ground, granulated blast furnace slag of the hydraulic cementitious mixture of the inventive composition is a critical component of the composition. It is primarily responsible for the final strength development of the floor underlayment or other hardened mass formed with the inventive composition. It has been observed that the ground, granulated blast furnace slag also improves the durability of the hardened mass to water, compared to gypsum plaster alone. Granulated blast furnace slag is a class of blast furnace slag formed by rapidly cooling the slag from blast furnace. Ground granulated blast furnace slag is a finely ground version of granulated blast furnace slag. It is ground to increase the surface area, thereby improving its reactivity.

Granulated blast furnace slag is available in ground form from a variety of sources. A particularly preferred ground, granulated blast furnace slag is available from LaFarge North America, Inc. of Herndon, Va., and marketed under the trademark NewCem®.

The ground, granulated blast furnace slag is preferably ground in a ball mill. The ground, granulated blast furnace slag preferably has a particle size such that at least about 90% by weight of the slag particles, based on the total weight of the slag particles, and more preferably essentially all of the slag particles, will pass through a No. 100 (150 microns) U.S. Standard sieve.

The gypsum plaster of the hydraulic cementitious mixture of the inventive composition is also a critical component. Hydration of the gypsum plaster is primarily responsible for the initial hardening of the composition. The gypsum plaster is preferably selected from the group consisting of alpha-calcium sulfate hemihydrate, beta-calcium sulfate hemihydrate and mixtures thereof. Most preferably, the gypsum plaster is alpha-calcium sulfate hemihydrate.

The gypsum plaster is preferably finely ground to a particle size such that at least about 90% by weight of the gypsum particles, based on the total weight of the gypsum particles, and more preferably essentially all of the gypsum particles, will pass through a No. 100 (150 microns) U.S. Standard sieve. The gypsum plaster is available from a variety of sources. A particularly preferred alpha-calcium sulfate hemihydrate is available from Allied Custom Gypsum Plasterworks, L.L.C. of Norman, Okla. and marketed in association with the trademark DynaPlast™ Base Alpha.

The cement plasticizer is also a critical component of the inventive hydraulic cement composition. The cement plasticizer is included in the composition to impart a greater plasticity, fluidity, homogeneity and slump to the composition, and to reduce the amount of water that is required to achieve such properties. The cement plasticizer also acts as a dispersing agent, particularly for the ground, granulated blast furnace slag and the gypsum plaster. A variety of cement plasticizers, also known as superplasticizers, water reducing agents and dispersing agents, can be used. The cement plasticizer is preferably selected from the group consisting of naphthalene sulfonate formaldehyde polycondensates, sulfonated melamine polycondensates, polyether carboxylates, and acrylic latex based dispersants. The particular cement plasticizer(s) used will depend on the intended use of the composition and the desired flowability, water demand, cost, and other factors. The most preferred group of cement plasticizers include Melflux 1641F, 2641F, 2651F® from BASF Chemicals, Lomar® D from Dow Chemical, FL51 from Elotex AG, and Melment F17G from BASF Construction Chemicals.

The cement plasticizer is preferably present in the inventive composition in an amount in the range of from about 0.03% to about 2% by weight, more preferably from about 0.03% to about 1.0% by weight, based on the total weight of the composition. The precise amount of the cement plasticizer that is used within the above ranges will depend on the type and potency of the specific cement plasticizer(s) used, the type of gypsum plaster used (alpha-calcium sulfate hemihydrate requires less because of its inherent low water demand and capacity for achieving a high compressive strength), the desired water demand and the desired compressive strength for the intended use of the composition. In one embodiment, the cement plasticizer is preferably present in the inventive composition in an amount in the range of from about 0.1% to about 0.6%, more preferably from about 0.25% to about 0.4%, by weight, based on the total weight of the composition.

Various additives can be included in the inventive composition depending on the application(s) in which composition is to be used. Examples of additional components that can be used include set modifying agents for the gypsum plaster, set modifying agents for the blast furnace slag, gypsum hydration expansion controlling agents, flow enhancing polymers, antifoaming agents and rheology modifying agents.

Set modifying agents can be used to retard or accelerate the amount of time it takes the hydraulic cementitious materials employed in the inventive composition to set. Examples of suitable set retarding agents for the gypsum plaster include protein-based amino acid blends, citric acid, one or more soluble salts (e.g., monovalent metal salts) of citric acid, boric acid, tartaric acid, and sodium bicarbonate. Of these, either tri-sodium citrate (available from Archer Daniels Midland), or a protein-based amino acid blend known as Plastretard PE from Charles B. Chrystal Co. of New York, N.Y. are preferred. The gypsum plaster set retarding agent is preferably present in the composition in an amount in the range of from about 0.05% to about 0.1% by weight. The preferred amount is specifically dependent on the desired set time and the amount, if any, of any set accelerating agent present. Suitable set accelerating agents for the gypsum plaster include finely ground gypsum, potassium sulfate, zinc sulfate and aluminum sulfate. Of these, a finely ground gypsum is preferred. When used, the set accelerating agent for the gypsum plaster is preferably present in the composition in an amount in the range of from about 0.03% to about 0.5% by weight, more preferably from about 0.03% to about 0.06% by weight, based on the total weight of the composition. Accelerating agents are used to improve compressive strength and reduce separation and surface bleed water, and for other reasons known to those skilled in the art. Set modifying agents are used to create hydration characteristics favorable for the intended use and vary greatly in potency. For the purpose of pourable underlayments, a desirable set time is between 1 and 3 hours, and a surface hardness sufficient for light construction trade traffic the following day.

The inventive composition can also include a gypsum hydration expansion controlling agent. The gypsum hydration expansion controlling agent functions to limit the expansive nature of the gypsum plaster as it hydrates. The preferred expansion controlling agent in the inventive composition is potash (potassium sulfate). When used, the gypsum hydration expansion controlling agent is preferably present in the composition in an amount of from about 0.1% to about 0.4% by weight, more preferably from about 0.1% to about 0.25% by weight, based on the weight of the composition.

The cement composition can also include one or more flow enhancing polymers such as vinyl acetate or vinyl ethyl acetate copolymers. In addition to making cement mixtures formed with the composition more flowable and more self leveling, such compounds also function to reduce water permeability properties and improved flexibility (reduced brittleness). When used, the flow enhancing polymer is preferably present in the inventive composition in an amount in the range of from about 0.1% to about 5% by weight, more preferably about 0.25% by weight, based on the total weight of the composition.

An anti-foaming agent can also be included in the composition. Examples of suitable anti-foaming agents include commercially available products such as Foamaster CN, and Geo FM PD#1 from Geo Specialty Chemicals of Cedartown, Ga. When used, the anti-foaming agent is preferably present in the composition in an amount in the range of from 0.05% to about 0.2% by weight, more preferably from about 0.06% to about 0.09% by weight, based on the total weight of the composition.

A rheology modifying agent can also be included in the inventive composition to reduce the bleed of water and fine particulates to the surface of cement mixtures formed using the inventive composition, as well as to increase the viscosity and uniformity of the mixed composition. The rheology modifying agents are typically long chain polysaccharides or heteropolysaccharides of high molecular weight with or without modifying groups attached to the hydroxyl groups of the pyranose rings. Examples include xanthan gum (Kelzan® from CP Kelco, Atlanta, Ga.), diutan gum (KelcoCrete® 200 from CP Kelco) and cellulose ethers (Methocel® from Dow Chemical). Proprietary long chain high molecular weight synthetic polymers such Melvis® and Starvis® from BASF Construction Chemicals are also beneficial. When used, the rheology modifying agent is present in the composition in an amount in the range of from about 0.0005% to about 0.5% by weight, more preferably in an amount in the range of from about 0.005% to about 0.1% by weight based on the total weight of the composition and depending on the effectiveness and degree of thickening that a particular additive will cause in the mixed composition.

As understood by those skilled in the art, additional additives that can be used in connection with the inventive composition as well depending on the intended use of the composition. Examples include dispersible silicone and wax powders such as Seal 80 from Elotex to reduce water permeability, surface hardening agents such as HD1501 from Elotex and pigments for affecting the color of the hardened mass.

A preferred embodiment of a floor underlayment cement composition in accordance with the invention is show by Table I below.

TABLE I
INVENTIVE FLOOR UNDERLAYMENT CEMENT COMPOSITION

| | PREFERRED | MORE PREFERRED |
|---|---|---|
| | AMOUNTS | AMOUNTS |
| COMPONENT | (wt. %)¹ | (wt. %)¹ |
| Hydraulic cementitious mixture | 95–99.97 | 99–99.97 |
| GGBFS³ | 35–65² | 50–55 |
| Gypsum plaster⁴ | 35–65² | 45–50² |
| Cement plasticizer⁵ | 0.1–0.60¹ | 0.25–0.4¹ |
| Set retarding agent⁶ | 0–0.25¹ | .05–0.1¹ |
| Set accelerator⁷ | 0–0.1¹ | 0.03–0.06¹ |
| Defoamer⁸ | 0–0.12¹ | 0.06–0.09¹ |

¹The percent by weight of the component based on the total weight of the floor underlayment cement composition
²The percent by weight of the component based on the total weight of the hydraulic cementitious mixture
³Ground, granulated blast furnace slag from LaFarge Corp.
⁴Alpha-calcium sulfate hemihydrate from Allied Custom Gypsum Plasterworks, LLC
⁵FL51 from Elotex
⁶Sodium citrate powder from ADM
⁷finely ground gypsum from ACG Plasterworks
⁸FM PD#1 from Geo Specialty Chemicals

The inventive composition meets the definition for hydraulic cement provided by ASTM C 219-03, namely a cement that sets and hardens by a chemical interaction with water and that is capable of doing so under water. The composition is a powdered particulate solid, preferably having a particle size such that at least about 98% by weight of the particles, based on the total weight of the particles, pass through a No. 100 (150 microns) U.S. Standard sieve. If necessary, the composition can be mechanically reduced by grinding to achieve the desired particle size. The components of the invention can be blended together using conventional solids mixing equipment such as paddle mixer.

In use, the dry composition is combined with an additional aggregate and water to form a pumpable, free-flowing, self-leveling cement mixture. The amount of additional aggregate used will depend on the desired compressive strength and desired smoothness of the finished underlayment. The water is provided in an amount sufficient to provide a free-flowing, pumpable, predominantly self-leveling and self-smoothing mixture. The precise amount of water used will depend on the amount of additional aggregate and characteristics of the aggregate. Overly coarse sands or fine sands can affect the flowability of the mixture, and greater amounts of sand require more water to obtain a free flowing slurry.

Preferably, the additional aggregate is added to the dry inventive composition in an amount such that the dry composition and the additional aggregate are present in the cement mixture in a weight ratio in the range of from about 1:1 to about 1:2.25, more preferably in the range of from about 1:1.25 to about 1:2.0, most preferably about 1:1.5. For example, the aggregate can be added to the dry composition such that it is present in an amount in the range of from about 1.0 cubic feet to about 1.8 cubic feet per 80 pounds of the dry composition (excluding the additional aggregate).

The additional aggregate is most preferably sand. The particle size of the sand is important as discussed above. The sand preferably includes only a small amount of clay and silt, if any, as these components increase the water demand of the mixture. There are all types of clean washed sands available and there are many different recommendations on what is optimal. Most pourable floor underlayments use fine washed silica sands, but coarser sands can be used. For thinner pours, finer sands are preferred. Sands that are too coarse reduce the flow and can separate in the mixture. Other aggregates may be suitable as long as they are inert and do not have contaminants that will affect the flow (too coarse or clay/silt contamination).

Water is added to the composition along with additional aggregate (in the amounts above) so that the result is a desirable free flowing slurry. In the case of the inventive composition for use as a pourable underlayment, a slump size of 9″ to 11″ on a Plexiglas surface using a 4″ tall 2″ i.d. plastic slump tube is desired. Water amounts can vary from about 3 to 5 gallons per 80 lbs of dry composition (excluding additional aggregate) depending on the amount of sand, type of gypsum plaster and amount of cement plasticizer that is used.

In a preferred floor underlayment cement mixture of the invention, the hydraulic cement composition set forth in Table I above is combined with water and washed, evenly graded sand between a 4 Mesh and 100 Mesh screen (finer sands can be used as long as contaminating clay and silt is minimized). The sand is added to the hydraulic cement composition in an amount such that the hydraulic cement composition and sand are present in the cement mixture in a weight ratio of 1:1.5. Water is added to the cement mixture in an amount sufficient to produce a free flowing slurry with a slump on Plexiglas between 9″-11″.

The resulting cement mixture has a free flowing viscosity and can be applied in thicknesses ranging from about 0.25 inches to about 1.5 inches without the occurrence of substantial shrinkage or expansion during the hardening process. It sets up into a hardened mass having a compressive strength of at least about 1000 psi within about 24 hours after the mixture is poured (the set time can be shortened or extended with set modifying agents as discussed above). The underlayment can be walked on at this time. Shrinkage, cracking and other problems during the hardening process and thereafter are minimal. The cement mixture ultimately hardens over a 28 day curing period into a slab having a compressive strength in the range of from about 2,000 psi to about 8,000 psi when tested by ASTM C109 and oven dried. Hydration of the gypsum plaster is primarily responsible for the early strength development, while hydration of the silicates and aluminosilicates of calcium in the blast furnace slag increases the compressive strength over the 28 day curing period.

The initial and final compressive strengths achieved by the inventive cement mixture can be controlled by varying the amount of water added to the mixture and by the amount of additional aggregate that is added to the mixture. A proper balance must be achieved. For example, sufficient water is needed to make the mixture free flowing, but too much water will decrease the sand carrying capacity of the mixture and ultimately the compressive strength of the hardened mass. The amounts of the additional aggregate and water set forth above provide maximum fluidity and sand carrying capacity while still providing sufficient compressive strength.

In accordance with the inventive method of forming a high strength floor underlayment, the floor underlayment cement composition of the invention, as set forth above, is prepared or provided. Thereafter, the cement composition is combined with an additional aggregate and water to form the inventive floor underlayment cement mixture, as set forth above. The cement composition, additional aggregate and water can be combined by any means known to those skilled in the art.

A primer is used to prepare the surface. It is preferably a water based acrylic primer sold as AccuCrete Primer/Sealer by Allied Marketing Systems LLC of Propsect Park, Pa. No shot blasting or surface grinding is required over concrete provided that the concrete does not have any loosely bonded materials on the surface. Loose grout, adhesives, oil, or power troweled cement with thin loosely adhered cement paste on the surface must be abraded and removed.

Next, the floor underlayment cement mixture is pumped onto the base surface. The mixture is preferably pumped onto the base surface by rotor-stator type pump (or can be barrel mixed and poured out on the floor). It is pumped to a thickness of ¼″ to 1.5″ and finished. Thin edges can be featheredged to meet the contour of the subfloor.

Thereafter, the cement mixture is allowed to set into an underlayment having a compressive strength in the range of from about 2,000 psi to about 8,000 psi. The mixture is screened to a desired thickness, or poured to the top of leveling pins, and then floated quickly with a long float (approximately 4′ in length). The underlayment includes excellent finishability properties (e.g., lack of tooling marks in the surface), is suitable for commercial or industrial use, and is a suitable surface to be covered by glued down or floating finished floor goods.

The hydraulic cement composition and cement mixture of the invention are particularly useful for forming floor underlayments; however, they can be used for other applications as well. For example, the inventive composition and mixture can be used to make flowable mortar or concrete for use as an anchoring cement and/or floor patching compound. It may also be used to cast shapes using molds.

In order to further illustrate the compositions and methods of this invention, the following examples are provided.

### EXAMPLE I

A cementitious mixture was made consisting of approximately 35% ground granulated blast furnace slag and 65% alpha calcium sulfate hemihydrate. To this mixture, 0.29% Lomar® D cement plasticizer was added along with 0.0125% trisodium citrate from Archer Daniels Midland. Fifty pounds of this mixture were mixed with 50 pounds of sand and 2.6 gallons of water. These components were mixed thoroughly in a barrel using a drill and mixing paddle and poured out onto a 4 foot by 4 foot formed plywood panel. The poured slurry was floated with a wooden float and allowed to harden. No sand was noticed settling to the bottom of the poured mixture, and it was easily finished. The vicat set time on the mixture was 45 minutes (ASTM C472). No cracks developed in the hardened panels. Cube molds were filled with the slurry and allowed to harden before being wrapped in wet paper towels and stored in a sealed container for 3, 7, and 28 days. Once the prescribed wet curing time was completed, the cubes were placed in a 45° C. drying oven and allowed to try to a constant weight. Compressive strength results are as follows: 3 day: 5,740 psi; 7 day: 6,055 psi; and 28 day: 6,334 psi.

### EXAMPLE II

A cementitious mixture was made consisting of approximately 50% ground granulated blast furnace slag and 50% alpha calcium sulfate hemihydrate. To this mixture, 0.29% Lomar® D cement plasticizer was added along with 0.0125% trisodium citrate from Archer Daniels Midland. Fifty pounds of this mixture were mixed with 50 pounds of sand and 2.4 gallons of water. These components were mixed thoroughly in a barrel using a drill and mixing paddle and poured out onto a 4 foot by 4 foot formed plywood panel. The slump of the slurry was 10″ measured on clean Plexiglas. The poured slurry was floated with a wooden float and allowed to harden. No sand was noticed settling to the bottom of the poured mixture, and it was easily finished. The vicat set time on the mixture was 40 minutes (ASTM C472). No cracks developed in the hardened panels. Cube molds were filled with the slurry and allowed to harden before being wrapped in wet paper towels and stored in a sealed container for 3, 7, and 28 days. Once the prescribed wet curing time was completed, the cubes were placed in a 45° C. drying oven and allowed to dry to a constant weight. Compressive strength results are as follows: 3 day: 6,112 psi; 7 day: 6,397 psi; and 28 day: 6,807 psi.

### EXAMPLE III

A cementitious mixture was made consisting of approximately 65% ground granulated blast furnace slag and 35% alpha calcium sulfate hemihydrate. To this mixture, 0.29% Lomar® D cement plasticizer was added along with 0.0125% trisodium citrate from Archer Daniels Midland. Fifty pounds of this mixture were mixed with 50 pounds of sand and 2.4 gallons of water. These components were mixed thoroughly in a barrel using a drill and mixing paddle and poured out onto a 4 foot by 4 foot formed plywood panel. The slump of the slurry was 10″ measured on clean Plexiglas. The poured slurry was floated with a wooden float and allowed to harden. No sand was noticed settling to the bottom of the poured mixture, and it was easily finished. The vicat set time on the mixture was 43 minutes (ASTM C472). No cracks developed in the hardened panels. Cube molds were filled with the slurry and allowed to harden before being wrapped in wet paper towels and stored in a sealed container for 3, 7, and 28 days. Once the prescribed wet curing time was completed, the cubes were placed in a 45° C. drying oven and allowed to dry to a constant weight. Compressive strength results are as follows: 3 day: 6,094 psi; 7 day: 6,381 psi; 28 day: 6,902 psi.

The primary difference among the above three described examples is the amount of time for the surface of the poured underlayment to harden completely. It is common and not surprising that compositions containing more gypsum plaster harden completely on the surface more rapidly than compositions with more ground granulated blast furnace slag.

### EXAMPLE IV

Field test on approximately 30,000 square feet of pre-cast concrete plank floors: A cementitious mixture was made consisting of approximately 53% ground granulated blast furnace slag and 47% alpha calcium sulfate hemihydrate. To this mixture, 0.30% Elotex FL51 cement plasticizer, 0.0125% trisodium citrate from Archer Daniels Midland, and 0.08% Foamaster PD#1 from Geo Specialty Chemicals was added. At the construction site, a mix ratio of 80 pounds of the above mixture, 1.2 cubic feet of sand (known as Tucahoe Plaster Sand), and approximately 4 gallons of water were added, thoroughly mixed in a Placer Pump by Strong Manufacturing, and then pumped into the building. Approximately 30,000 square feet of this mixture was installed at a thickness of approximately ½″ to ¾″. After 28 days, no cracks were observed, while the finished appearance of the floor was uniform and without float marks. The slump of the mixture measured on clean Plexiglas was between 9.25″ and 9.50″. Compressive strengths were measured on three different sets of 2″ cubes as described in the above examples. Compressive strengths ranged on these cube sets between 4,565 psi and 5,260 psi. No cracks were observed 7 and 28 days after the floor was poured, with the exception of an area of the building that was not enclosed and exposed to several hours of direct sunlight and wind each day of the curing process. These cracks appeared after 4 days, and are not believed to representative of the composition's performance since it was used in an area for which its use is not intended (outdoors or exposed environment), and it occurred in a very small area relative to the overall size of the test area. The concrete floor was prepared with an application of AccuCrete Primer/Sealer (acrylic sealer) and was thoroughly coated and allowed to dry completely before the slurry was placed. No bead blasting or surface grinding was needed.

Thus, the present invention is well adapted to carry out the objects and attain the benefits and advantages mentioned as well as those which are inherent therein. While numerous changes may suggest themselves to those skilled in the art, such changes are encompassed by this invention as defined by the appended claims.

What is claimed is:

1. a hydraulic cement composition, comprising:
at least about 95% by weight, based on the weight of the composition, of a hydraulic cementitious mixture, said hydraulic cementitious mixture including:
in the range of from about 35% to about 65% by weight, based on the weight of the mixture, of ground, granulated blast furnace slag; and in the range of from about 35% to about 65% by weight, based on the weight of the mixture, of a gypsum plaster.

2. The composition of claim 1 further comprising at least about 0.03% by weight, based on the weight of the composition, of a cement plasticizer.

3. The composition of claim 1, wherein said hydraulic cementitious mixture includes in the range of from about 50% to about 60% by weight of said ground, granulated blast furnace slag, and in the range of from about 40% to about 50% by weight of said gypsum plaster, said weight percents being based on the weight of said mixture.

4. The composition of claim 3, wherein said hydraulic cementitious mixture includes in the range of from about 50% to about 55% by weight of said ground, granulated blast furnace slag, and in the range of from about 45% to about 50% by weight of said gypsum plaster, said weight percents being based on the weight of said mixture.

5. The composition of claim 1, wherein said hydraulic cementitious mixture consists of said ground, granulated blast furnace slag and said gypsum plaster.

6. The composition of claim 5, wherein said hydraulic cementitious mixture consists of in the range of from about 50% to about 60% by weight of said ground, granulated blast furnace slag, and in the range of from about 40% to about 50% by weight of said gypsum plaster, said weight percents being based on the weight of said mixture.

7. The composition of claim 6, wherein said hydraulic cementitious mixture consists of in the range of from about 50% to about 55% by weight of said ground, granulated blast furnace slag, and in the range of from about 45% to about 50% by weight of said gypsum plaster, said weight percents being based on the weight of said mixture.

8. The composition of claim 1, wherein said composition comprises in the range of from about 95% to about 99.97% by weight of said hydraulic cementitious mixture, and in the range of from about 0.03% to about 2% by weight of said cement plasticizer, said weight percents being based on the weight of said composition.

9. The composition of claim 1, wherein said ground, granulated blast furnace slag has a particle size such that at least about 90% by weight of the slag particles, based on the total weight of the slag particles, pass through a No. 100 (150 microns) U. S. Standard sieve.

10. The composition of claim 1, wherein said gypsum plaster is selected from the group consisting of alpha-calcium sulfate hemihydrate, beta-calcium sulfate hemihydrate, and mixtures thereof.

11. The composition of claim 1, wherein said gypsum plaster is alpha-calcium sulfate hemihydrate.

12. The composition of claim 1, wherein said cement plasticizer is selected from the group consisting of naphthalene sulfonate formaldehyde polycondensates, sulfonated melamine polycondensates, polyether carboxylates, and acrylic latex based dispersants.

13. The composition of claim 1, further comprising one or more additives selected from the group consisting of set modifying agents for the gypsum plaster, gypsum hydration expansion controlling agents, flow enhancing polymers, antifoaming agents, rheology modifying agents, surface hardening agents, and additives for reducing the permeability of water in the hardened mass.

14. The composition of claim 1, further comprising a gypsum plaster set modifying agent.

15. The composition of claim 14, wherein said gypsum plaster set modifying agent includes a set retarding agent selected from the group consisting of protein-based amino acid blends, citric acid, one or more soluble salts of citric acid, boric acid, tartaric acid, and sodium bicarbonate.

16. The composition of claim 15, wherein said set retarding agent is trisodium citrate or a protein-based amino acid blend.

17. The hydraulic cement composition of claim 15, wherein said gypsum plaster set modifying agent includes a set accelerating agent.

18. The composition of claim 17 wherein said set accelerating agent is selected from the group consisting of finely ground gypsum, potassium sulfate, zinc, sulfate, and aluminum sulfate.

19. The composition of claim 18, wherein said gypsum component set accelerating agent is finely ground gypsum.

20. The hydraulic cement composition of claim 1, further comprising in the range of from about 0.1% to about 0.25% by weight, based on the weight of the composition, of a gypsum hydration expansion controlling agent.

21. The composition of claim 20, wherein said gypsum hydration expansion controlling agent is a potassium salt.

22. The hydraulic cement composition of claim 1, further comprising in the range of from about 0.1% to about 5% by weight, based on the weight of the composition, of a flow enhancing polymer.

23. The hydraulic cement composition of claim 1, further comprising in the range of from about 0.05% to about 0.2% by weight, based on the weight of the composition, of an anti-foaming agent.

24. The composition of claim 23, wherein said anti-foaming agent is a petroleum distillate derivative or an organic phosphate.

25. The hydraulic cement composition of claim 1, further comprising in the range of from about 0.0005% to about 0.5% by weight, based on the weight of the composition, of a rheology modifying agent.

26. The composition of claim 25, wherein said rheology modifying agent is selected from the group consisting of xanthan gum, diutan gum, cellulose ethers, and other long chain high molecular weight organic polymers

27. A floor underlayment cement composition, comprising:
at least about 95% by weight, based on the weight of the composition, of a hydraulic cementitious mixture, said hydraulic cementitious mixture consisting of:
in the range of from about 35% to about 65% by weight, based on the total weight of the mixture, of ground, granulated blast furnace slag; and
in the range of from about 35% to about 65% by weight, based on the weight of the mixture, of a gypsum component selected from the group consisting of alpha-calcium sulfate hemihydrate, beta-calcium sulfate hemihydrate and mixtures thereof; and
at least about 0.03% by weight, based on the weight of the composition, of a cement plasticizer.

28. A floor underlayment cement mixture, comprising:
a floor underlayment cement composition, said floor underlayment cement composition including:
at least about 95% by weight, based on the weight of the composition, of a hydraulic cementitious mixture, said hydraulic cementitious mixture including:
in the range of from about 35% to about 65% by weight, based on the weight of the mixture, of ground, granulated blast furnace slag; and
in the range of from about 35% to about 65% by weight, based on the weight of the mixture, of gypsum plaster; and
at least about 0.03% by weight, based on the weight of the composition, of a cement plasticizer;
additional aggregate, said floor underlayment hydraulic cement composition and said additional aggregate being present in said mixture in a weight ratio in the range of from about 1:1 to about 1:2.25; and
water present in an amount sufficient to provide a flowable, self-leveling mixture.

29. A method of forming a high strength floor underlayment on a base surface, comprising:
(a) preparing or providing a floor underlayment cement composition, said floor underlayment cement composition including:
at least about 95% by weight, based on the weight of the composition, of a hydraulic cementitious mixture, said hydraulic cementitious mixture including:
in the range of from about 35% to about 65% by weight, based on the weight of the mixture, of ground, granulated blast furnace slag; and
in the range of from about 35% to about 65% by weight, based on the weight of the gypsum plaster; and
at least about 0.03% by weight, based on the weight of the composition, of a cement plasticizer;
(b) combining said floor underlayment cement composition with an additional aggregate and water to form a cement mixture, said floor underlayment cement composition and said additional aggregate being present in said mixture in a weight ratio in the range of from about 1:1 to about 1:2.25, said water being present in said mixture in an amount sufficient to provide a flowable, self-leveling mixture;
(c) placing said mixture on said floor; and
(d) allowing said mixture to set in to an underlayment having a compressive strength in the range of from about 1,000 psi to about 8,000 psi.
